(19) United States
(12) Patent Application Publication
(10) Pub. No.: US 2013/0001977 A1
(43) Pub. Date: Jan. 3, 2013

(54) ROTATABLE GLARE SHIELD FOR A VISOR

(75) Inventor: Jonathan P. Marcus, Holland, MI (US)

(73) Assignee: Marcus Automotive, LLC, Holland, MI (US)

(21) Appl. No.: 13/530,226

(22) Filed: Jun. 22, 2012

Related U.S. Application Data
(60) Provisional application No. 61/503,358, filed on Jun. 30, 2011.
(60) Provisional application No. 61/542,388, filed on Oct. 3, 2011.

(51) Int. Cl. B60J 3/02; B60J 3/06

(52) U.S. Cl. 296/97.6; 296/97.8

(57) ABSTRACT

A vehicle visor includes a visor body and a pivot mount for mounting the visor body to a vehicle for movement from a stored position to a lowered use position. The visor includes an auxiliary glare shield pivotally mounted to the visor body on a side of the visor body, such that it can be rotated from a stored position adjacent and substantially coplanar with the visor body to a use position extending away from the visor body for providing supplemental sun screening. In a preferred embodiment, the auxiliary glare shield includes a lever mounted to an edge of the visor body for rotating the auxiliary glare shield between stored and use positions. In a preferred embodiment also, the pivot mount for the visor body allows its movement in a direction away from a vehicle windshield when lowered for use.

### CROSS-REFERENCE TO RELATED APPLICATIONS

This application claims priority under 35 U.S.C. §119(e) and the benefit of U.S. Provisional Application No. 61/503,358 entitled ROTATING GLARE SHIELD FOR VISORS, filed on Jun. 30, 2011, by Jonathan P. Marcus; and U.S. Provisional Application No. 61/542,388 entitled ROTATABLE AUXILIARY VISOR AND GLARE SHIELD, filed on Oct. 3, 2011, by Jonathan P. Marcus, et al., the entire disclosures of which are incorporated herein by reference.

### BACKGROUND OF THE INVENTION

The present invention relates to vehicle sun visors.

Typically visors are mounted to a vehicle with a pivot hinge arrangement coupled to the vehicle roof near or at the A-pillar of the vehicle. When used, such visors are pivoted downwardly in a direction toward the windshield passing momentarily through the forward line of sight of the occupant as it is moved to a sun-blocking position. Also, conventional visor mounts frequently employ an auxiliary releasing clip at an end opposite the pivot connection to allow the visor to be released from the front windshield position and pivoted to a side window position. When so manipulating a visor, it sometimes becomes necessary for the occupant to duck his/her head to allow the visor to pass through the head area of the vehicle interior.

With such conventional mounting systems for vehicle visors, at least two safety issues are presented. First, the operator is momentarily distracted while manipulating the visor for use either in the front windshield position, since it passes through the line of sight, and again when it is pivoted to a side window position. Secondly, when pivoted downwardly, the visor may in some adjusted positions present an edge which projects toward the user's head. In the event of an accident, this could cause serious injury despite requirements that the edges are curved.

Newer vehicle designs have become more aerodynamic, partly to conserve fuel, and, in such designs, conventional visor mounting systems place the visors further rearwardly even closer to the occupant's head, which makes it more difficult for the vehicle operator to manipulate the visor without distraction. Some visor systems include an auxiliary visor which can be moved independently of the main windshield visor to a side window position. Movement of such auxiliary visors likewise is through the driver's head zone and can cause a significant distraction while operating a motor vehicle.

Frequently, existing visors do not provide a sufficient area of sun-blocking protection. Many visor designs have been proposed to add an extendable slide-out panel to increase the size and, therefore, the sun-shielding capabilities of visors. One such design is disclosed in PCT Application No. PCT/US2011/033462 (WO 2011/133791), the disclosure of which is incorporated herein by reference. Although slide-out auxiliary glare shields improve the sun-blocking performance of the visor, they are somewhat expensive and add bulk (i.e., thickness) and weight to the visor.

There exists a need, therefore, for a visor system which can be mounted to a vehicle in a manner which provides excellent sun-blocking properties, is easy to maneuver, eliminates some of the safety issues, and still provides features to which consumers have become accustomed, such as illuminated vanity mirrors, extendable sun-blocking or filtering panels, side window protection, and the like.

### SUMMARY OF THE INVENTION

A vehicle visor includes a visor body and a pivot mount for mounting the visor body to a vehicle for movement from a stored position to a lowered use position. The visor includes an auxiliary glare shield pivotally mounted to the visor body on a side of the visor body, such that it can be rotated from a stored position adjacent and substantially coplanar with the visor body to a use position extending away from the visor body for providing supplemental sun screening. In a preferred embodiment, the auxiliary glare shield includes a lever mounted to an edge of the visor body for rotating the auxiliary glare shield between stored and use positions. Such an auxiliary glare shield is relatively inexpensive to manufacture and easy for the occupant to operate. In a preferred embodiment also, the pivot mount for the visor body allows its movement in a direction away from a vehicle windshield when lowered for use.

These and other features, objects and advantages of the present invention will become apparent upon reading the following description thereof together with reference to the accompanying drawings.

### BRIEF DESCRIPTION OF THE DRAWINGS

FIG. 1 is a front perspective view of a visor embodying the present invention;

FIG. 2 is a rear perspective view of the visor shown in FIG. 1;

FIG. 3 is a fragmentary enlarged view, partly in phantom form, of the coupling of the lower right corner (as seen in FIG. 2) of the auxiliary glare shield;

FIG. 4 is a fragmentary enlarged view, partly in phantom form, of the coupling of the lower left corner (as seen in FIG. 2) of the auxiliary glare shield;

FIG. 5 is a perspective view showing the visor installed in a vehicle and in a lowered use position, with the auxiliary glare shield deployed; and

FIG. 6 is a rear perspective view as seen through the windshield of the visor system, showing the auxiliary glare shield and the side window panel deployed.

### DETAILED DESCRIPTION OF THE PREFERRED EMBODIMENT

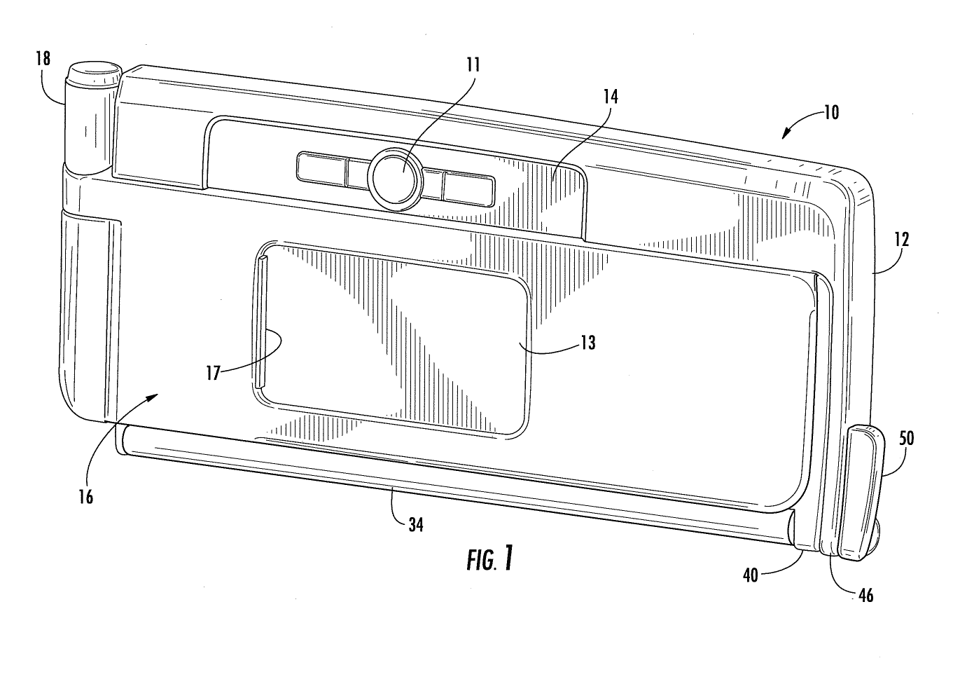

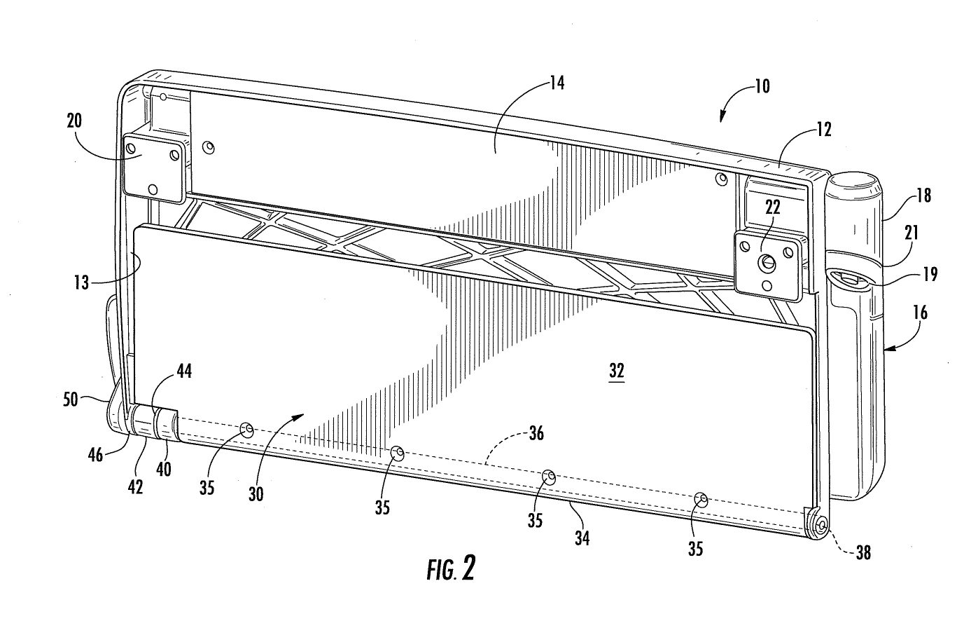

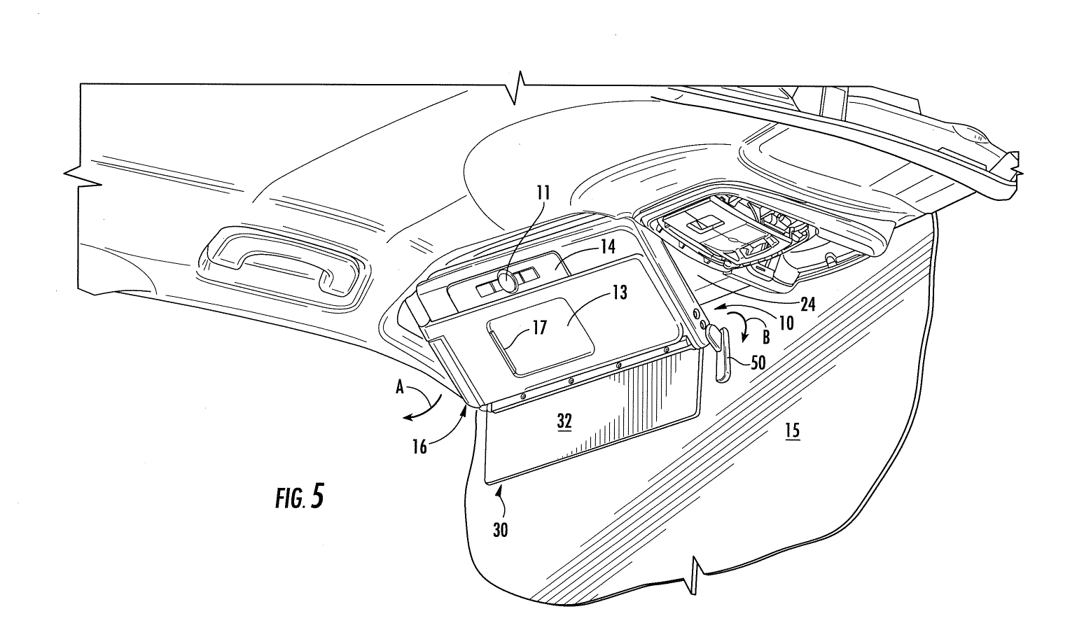

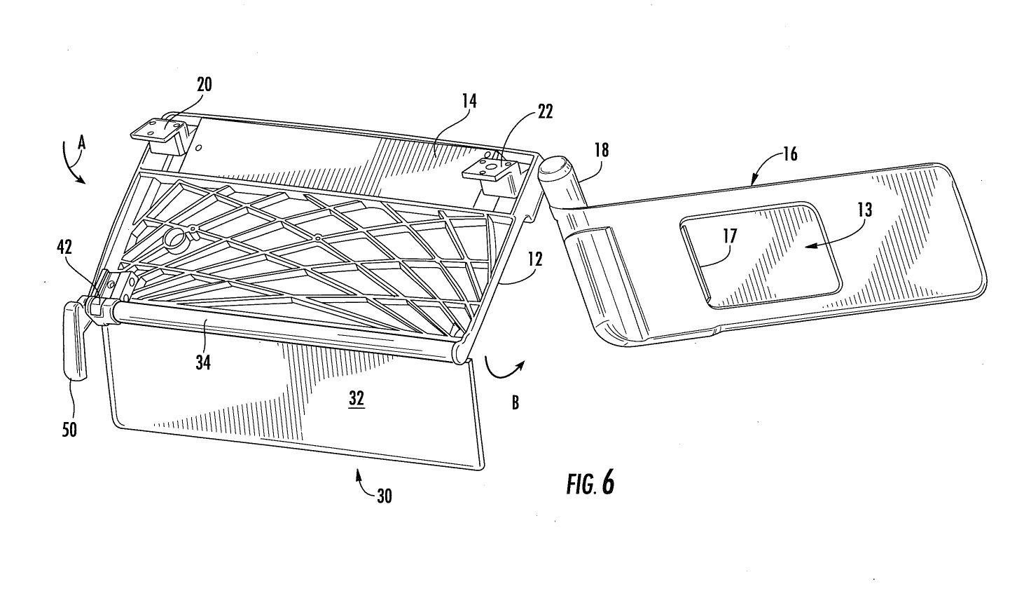

Referring initially to FIGS. 1 and 2, there is shown a visor 10 embodying the present invention. Visor 10 includes a visor body 12, which defines a frame for receiving the remaining components including a lighting package 14 with a source of illumination 11 for providing illumination to the interior of a vehicle, the intensity of which can be controlled as desired. The visor 10 further includes a side window auxiliary visor 16, which is pivotally mounted to a mounting bracket 18, for rotation between the stowed position shown in FIGS. 1 and 5 to a side window position, as illustrated in FIG. 6. The barrel-shaped bracket 18 rotates on a pivot axle 19 (FIG. 2) with respect to the visor body 12 with an angled interface 21, which allows the side window auxiliary visor to dip down when moved from a stored position to the side window. Thus, when moved, it does not encroach in the user's head space. The visor also includes pivot mounting hinges 20 and 22 for securing the visor to the headliner of a vehicle, such that the visor 10 can be moved downwardly, away from the windshield 15 (FIG. 5), and an auxiliary glare shield 30 deployed. Suitable spring cams are incorporated to hold the visor in a stored position within a recess 24 (FIG. 5) in the vehicle headliner.

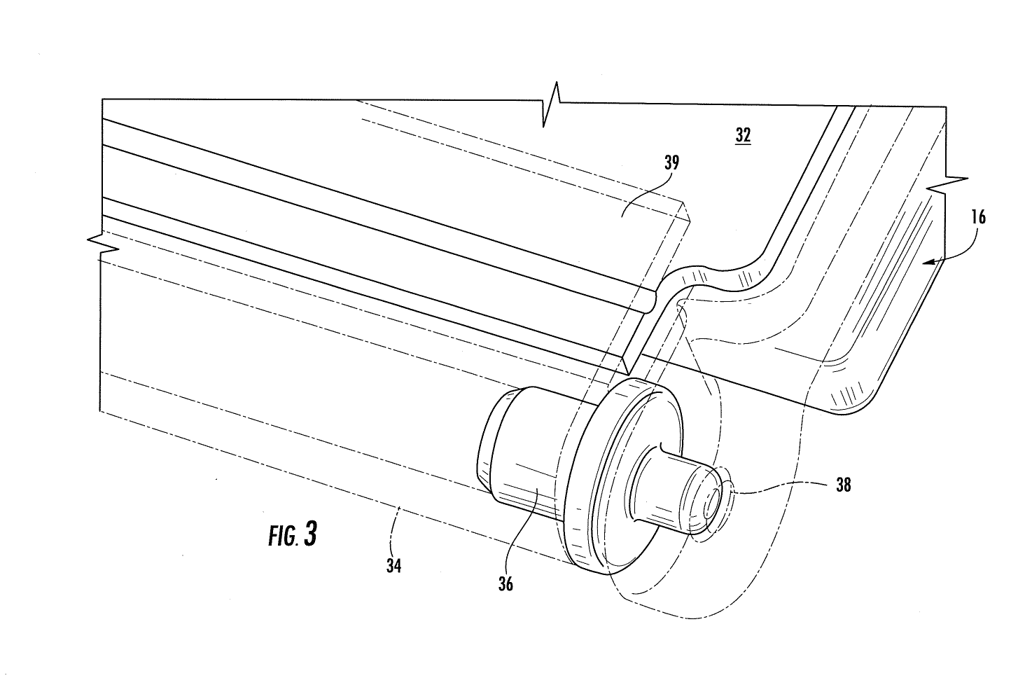

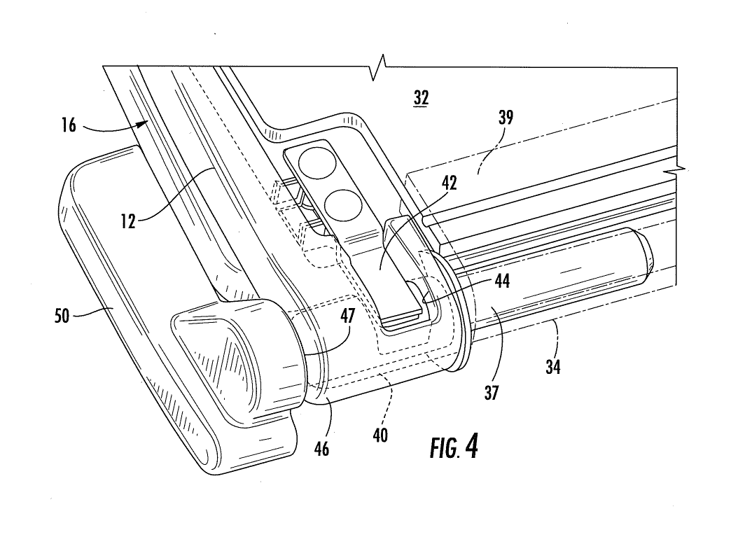

The auxiliary glare shield 30 comprises a generally planar body 32, which is attached to a flange 39 (FIGS. 3 and 4) of a cylindrical mounting collar 34. Collar 34 can be integrally molded with the auxiliary glare panel 32 of a suitable polymeric material or collar 34 can be separately secured to the panel with fasteners extending through apertures 35 (FIG. 2) into flange 39 to allow substitution or replacement of the panel 32 of the auxiliary glare shield 30. One end of auxiliary glare shield 30 includes a stub pivot axle 36 (FIG. 3) which has an end that extends into a blind aperture 38 at the lower right corner of the visor frame and is allowed to rotate in the aperture. As seen in FIG. 4, the lower left corner of visor 30 includes a cylindrical sleeve 40, which rotatably receives a stub pivot axle 37 fixedly mounted to collar 34. A metal spring torque clip 42 is mounted to visor body 12 with fasteners 43. Clip 42 has an end which extends within a slot 44 in the visor body 12 and engages pivot axle 37. This provides a friction engagement of the pivot axle to hold the auxiliary glare shield 30 in a selected adjusted position. An end 46 of the visor body 12 includes an aperture 47 through which the pivot axle 37 extends. A lever 50 is secured to the projecting end of axle 37 for rotating the axle and auxiliary glare shield 30 to a selected position. For such purpose, the end of pivot axle 37 engaging lever 50 can be adhesively bonded within an aperture in lever 50 to provide a fixed relationship between lever 50 and pivot axle 37 or set screws can be employed to secure the lever to the end of pivot axle 37. If desired, the lever can be replaced with a knob for rotation of the auxiliary glare shield.

In operation, the visor 10 is moved downwardly away from the windshield 15 in a direction indicated by arrow A in FIGS. 5 and 6. When in a lowered position, the auxiliary glare shield 30 can be pivoted from the back side of the visor body 12 (i.e., the side facing the windshield) in a direction indicated by arrow B in FIGS. 5 and 6 to position the panel 32 of the auxiliary glare shield 30 in a desired position extending the sunshield protection afforded by the visor 10. The glare shield panel 32 can be made of any suitable material, which can be one of opaque, micro-louver, transparent, tinted, translucent, polarized, or phototropic material. When stored as shown in FIGS. 1-4, auxiliary glare shield 30 is substantially coplanar with visor body 12 and nests within a recess 13 in the back side of the visor 10, as seen in FIG. 2.

The side window visor 16 may include an illuminated vanity mirror package 13 with a sliding cover 17 which, when opened, exposes an underlying mirror (not shown) and activates the lighting package 14 to provide illumination from light source 11 contained therein.

It will become apparent to those skilled in the art that various modifications to the preferred embodiment of the invention as described herein can be made without departing from the spirit or scope of the invention as defined by the appended claims.

The invention claimed is:

1. A vehicle visor including an auxiliary glare shield comprising:
a visor body;
a pivot mount for mounting said visor body to a vehicle for movement from a stored position to a lowered use position; and
an auxiliary glare shield pivotally mounted to said visor body on a side of said visor body, such that it can be rotated from a stored position adjacent and substantially coplanar with said visor body to a use position extending away from said visor body for providing supplemental sun screening.

2. The visor as defined in claim 1 wherein said pivot mount couples said visor body to the vehicle, such that said visor body moves in a direction away from a vehicle windshield when lowered for use.

3. The visor as defined in claim 2 wherein said auxiliary glare shield is mounted to said visor body facing the vehicle windshield.

4. The visor as defined in claim 3 wherein said visor body includes a frame and said glare shield includes at least one axle rotatably mounted to said frame such that said glare shield can be pivoted to selected use positions.

5. The visor as defined in claim 4 wherein said auxiliary glare shield is a panel and a lever is mounted to an edge of the visor body and coupled to sad axle for rotating said auxiliary glare shield between stored and use positions.

6. The visor as defined in claim 5 and further including a torque clip engaging said axle of said auxiliary glare shield to hold said glare shield in a position selected by the operator when said glare shield is rotated from a stored position.

7. The visor as defined in claim 1 wherein said auxiliary glare shield comprises a panel chosen from the group consisting of an opaque, micro-louver, transparent, tinted, translucent, polarized, and phototropic material.

8. A vehicle visor including an auxiliary glare shield comprising:
a visor body;
a pivot mount for mounting said visor body to a vehicle for movement between a stored position and a lowered use position; and
an auxiliary glare shield pivotally mounted to said visor body adjacent a side of said visor body in a plane parallel to said visor body, said auxiliary glare shield rotatable from a stored position adjacent said visor body to a use position extending away from said visor body for providing supplemental sun screening.

9. The visor as defined in claim 8 wherein said auxiliary glare shield comprises a panel made of one of an opaque, micro-louver, transparent, tinted, translucent, polarized, and phototropic material.

10. The visor as defined in claim 8 wherein said auxiliary glare shield includes a lever mounted to an edge of said visor body and coupled to said auxiliary glare shield for rotating said auxiliary glare shield between stored and use positions.

11. The visor as defined in claim 8 and further including a pair of stub axles extending from opposite ends of said auxiliary glare shield and rotatably received by said visor body, and a torque clip engaging one of said axles of said auxiliary glare shield to hold said glare shield in a position selected by the operator when said glare shield is rotated from a stored position.

12. A visor system for a vehicle comprising:
a primary visor having a body and mount to allow said visor body to be attached to a vehicle for pivotal movement from a raised stored to a lowered use position;
a side window visor panel including a pivotal mount for pivotally mounting the visor panel to a vehicle for pivoting to a side window position without encroaching in a user's space; and
an auxiliary glare shield pivotally mounted to said visor body adjacent a side of said visor body in a plane parallel to said visor body, said auxiliary glare shield rotatable from a stored position adjacent said visor body to a use position extending away from said visor body for providing supplemental sun screening.

13. The visor system as defined in claim 12 wherein said pivotal mount for said side window visor panel is a pair of cylinders coupled to each other at inclined surfaces.

14. The visor system as defined in claim 12 wherein said side window visor panel is stored against said primary visor and movable to a position adjacent a side window.

15. The visor system as defined in claim 12 wherein said primary visor includes a recess for receiving said side window visor panel.

16. The visor as defined in claim 12 wherein said auxiliary glare shield comprises a panel chosen from the group consisting of an opaque, micro-louver, transparent, tinted, translucent, polarized, and phototropic material.

17. The visor as defined in claim 16 wherein said auxiliary glare shield includes a lever mounted to an edge of said primary visor and coupled to said auxiliary glare shield for rotating said auxiliary visor between stored and use positions.

18. The visor as defined in claim 17 wherein said auxiliary glare shield includes an axle rotatably mounted to said visor body such that said glare shield can be pivoted to selected use positions.

19. The visor as defined in claim 20 and further including a torque clip mounted to said visor body and engaging said axle of said auxiliary glare shield to hold said glare shield in a position selected by the operator when said glare shield is rotated from a stored position.
